(19) United States
(12) Patent Application Publication
(10) Pub. No.: US 2010/0307222 A1
(43) Pub. Date: Dec. 9, 2010

(54) MEASURING INSTRUMENT FOR THE DETECTION AND EVALUATION OF AN IMPACT

(75) Inventor: Andreas Oberleitner, Zillingdorf (AT)

Correspondence Address: LERNER GREENBERG STEMER LLP, P O BOX 2480, HOLLYWOOD, FL, 33022-2480, US

(73) Assignee: AUSTRIAN RESEARCH CENTERS GMBH - ARC, Wien (AT)

(21) Appl. No.: 12/514,029

(22) PCT Filed: Nov. 7, 2007
(86) PCT No.: PCT/AT2007/000504

§ 371 Date: Jan. 19, 2010

(30) Foreign Application Priority Data
Nov. 7, 2006 (AT) 1851/2006

(51) Int. Cl. G01N 3/00

(52) U.S. Cl. 73/12.04

(57) ABSTRACT

A measuring device for detecting and evaluating an impact, jolt or the like is formed with an impact face, against which the impact, jolt or pulse which is to be evaluated strikes. A sensor, for example a force sensor, detects values of the force which act on the impact face as a result. A sensor, for example an acceleration sensor, detects values of the acceleration which act on the impact face as a result. An evaluation unit processes the determined force and acceleration values.

The invention concerns a measuring instrument in accordance with claim 1.

In martial arts, in particular in full contact sports and in self defense, one is anxious to increase by physical training the “impact effect”. Beside the physiological, psychological and tactical component, the physical component, i.e. physical parameters, like e.g. force, is the main aspect for the evaluation of the impact effect. The impact effect describes in principle the transmission of energy during this impact process. It concerns thereby dynamic processes, since the person affects the impact directly before, while and after the hit, for example by body exertion, influence of the times of contact etc. Besides that, also the person, who holds the target, affects the hit effect at mobile solutions. The simultaneous consideration of force, time and space and/or impact depth can be used for the determination of the so-called shock strength, i.e. a very high force occurring during a very short time period.

Forces in the biomechanics are mainly measured with force surface plates. Such plates are firmly connected with a reference system i.e. fastened to a rigid wall and measure the application of force on this rigid plate. However, such systems in the biomechanics can deal only with static or quasi-static forces, i.e. when slow changes of force and/or small amounts of force occur, since impacts with a large force and large acceleration are risky for injuries on such a rigid plate. In addition such systems can be used in measurements, where the applied forces move the exercising body away of the plate, e.g. during jump power measurement. Therefore, such systems are only conditionally or even not at all suited for impact force measurement. Besides such systems are very expensive in the acquisition, and usually not mobile, but assume an assembly at an immovable, rigid and massive body, e.g. a wall.

The direct application of such transducers in handheld equipment is therefore not possible (moving, not reproducibly flexible target) and requires a consideration of force and kinetic parameters. The available invention does make the determination possible for the first time, partially of the directly measurable characteristics substantial for the impact process. The realization takes place in accordance with the patent claims.

Particularly for the martial arts, there are already some beginnings, in order to objectivate training progress concerning the impact force. However, these are accommodated either in rigid constructions, which increases the danger of substantial injury, or only individual, parameters suitable to only a limited extent can be determined. For example the determination of the “impact effect” is missing, i.e. transfer of energy and their course of time.

So for example in GB 2,372,220, DE 20001615 U1 or EP 1 221 333 fixed surface plates mounted on walls are mentioned. Thereby the dangers of injury described above at impacts against a rigid obstacle are unfavourable. Besides, a yielding goal better simulates the real situation of a hit e.g. on a body.

Furthermore, measurement of force of an impact or the acceleration of the impact is well-known from the state of the art.

Thus for example a box bag with integrated Acceleration sensor is described in the DE 103 23 348 A1. From U.S. Pat. No. 6,611,782, a measuring instrument using a force sensor is well-known for the impact effect. Also the surface plates mentioned above measure either only force of the impact or its acceleration. All further necessary parameters are then deduced from this quantity.

However, such a measurement of only one value, thus of force or acceleration, works only with a constant well-known mass, as this is known, for example, with fixed mounted measuring plates and, hence, is not suited for a “hand held function” with which the measuring setup is held in the hand. Similar Handheld devices are known for example from U.S. Pat. No. 3,270,564 or U.S. Pat. No. 6,441,745 B1 at golf clubs or tennis racquets; however, also in those cases, either only force or acceleration is measured.

Task of the invention is to create a constructively simple and light measuring instrument with which the impact effect can be measured and judged. Furthermore, it is a task of the invention to design the measuring instrument constructionally in such a way that this is applicable as hand held equipment, which can be used particularly in martial arts training without danger of injury.

This task is solved by the characteristics of claim 1. The invention describes in favourable manner a portable hand held equipment, which measures and registers values of both force and acceleration, for example of an impact, and determines from this the affected mass, speed, way, momentum, transferred energy and power. These are meaningful parameters for the evaluation of the effect of a strike movement. By the registration of values of both parameters, i.e. force and acceleration, the measuring instrument becomes mass independent and thus is suited for hand held applications.

For the measurement of force and acceleration, sensors are included directly in the device. A controller system takes over the remaining processing. The arrangement of force and acceleration sensors directly in the impact pad allows an absolutely training-everyday life-suited employment without danger of injury. No preparations are to be carried out inevitably around the measurements, this leads to a plug-and-play-function. Moreover, the production costs are very small in comparison to other devices. The accessory can be held, as it is usual in the training, by a training partner and must not be mounted on a bearer or a wall what reduces, in addition, the danger of injuries considerably.

The number of directly measured parameters is with force and acceleration higher than for known devices, which determine only one size; therefore, the system is more meaningful. Thus, primarily force and acceleration are acquired. From this, a plurality of further parameters can be determined through physical connections. Beside the primary, actually already important parameters force and acceleration, in further consequence the speed, way, momentum, transferred energy, power can be computed. These parameters are essential for the evaluation of the impact and its effect, since these actually represent the parameters to optimize in training by motion technique.

A time- and track-dependent “pseudo inertia mass” respectively is assumed, which unite the effects of the genuine inertia mass, i.e. the system impact pad retaining arm and the additionally arising resistive forces, i.e. the additional muscle power of the holding arm. This value is not determinable with other one dimensional measuring systems, whereby the values specified above cannot be determined. This “pseudo inertia mass” is determined at each time in accordance with the sampling rate, whereby the system with the application of the physical connections already mentioned, e.g. the determination of the energy, the momentum etc., can be made independent of the knowledge of the mass and the resistance strengths.

Further favourable arrangements of the invention are demonstrated in the dependent claims. The favourable arrangement of the sensors in accordance with claim 2 ensures that the forces released by possible hits and/or impulses are easy and well measurable.

Favourable arrangements of the measuring instrument are given by the characteristics of claim 3. Like that it is possible to measure different performance parameters in different kinds of sport in order to judge and optimize the performance of the athlete objectively.

In order to avoid dangers of injury and to allow an effective arrangement of the sensors, it is favourable to realize the characteristics of the claim 4. Favourably applicable force sensors are given by the characteristics of claim 5.

In this context, it is particularly favourable to realize the characteristics of claim 6 since thereby a good force measurement can be achieved.

A favourable kind of acceleration sensors, with which accelerations are good and reproducibly measurable, is given by the characteristics of claim 7.

The acceleration sensors can be arranged in favourable way on the measuring instrument and/or target surface in accordance with claim 8 to 10. Thus it is possible to evaluate the acceleration of a strike or an impact in the best possible way and/or to analyze, even if the strike does not hit each time on the same position of the target surface and/or is placed somewhat decentralized. The arrangement of the acceleration sensors in accordance with these claims ensures also high reproducibility of the results of measurement.

The characteristics of the claims 11 to 14 describe favourable arrangements and designs of the force sensors. Thus it becomes possible to measure the forces, which affect the target surface, as reproducibly and well as possible and to achieve a high accuracy in relative independence from the exact position of the hit. This can be achieved particularly favourably by the characteristics of the claims 12 to 14.

An alternatively designed target surface, which is used in particular with Hand Mitts with a handle, is designed in accordance with claim 15.

A further possibility for the favourable arrangement of force sensors is given in accordance with the characteristics of claim 16.

The characteristics of claim 17 ensure a multifaceted processability of the results.

In claim 18 a training device is described, which covers a measuring instrument according to the invention, with which in different kinds of sport active or passive impact or impact processes can be analyzed. Thus, the measuring instrument is variously applicable.

Further advantages and arrangements of the invention result from the description and the enclosed designs. The invention is represented on the basis of implementation examples in the drawings schematically and is described in the following with reference to the drawings by way of example.

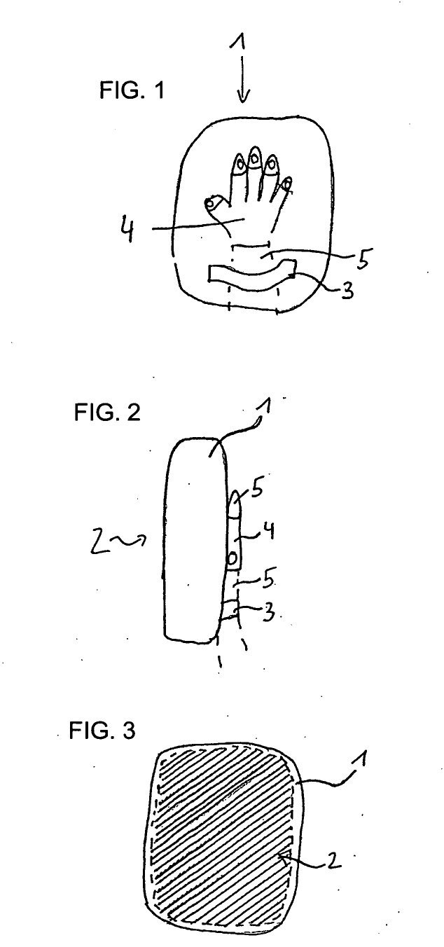

FIG. 1 shows the back of a measuring instrument according to the invention in form of a Coaching Mitt.

FIG. 2 shows a side view in accordance with FIG. 1.

FIG. 3 shows a front view in accordance with FIG. 1.

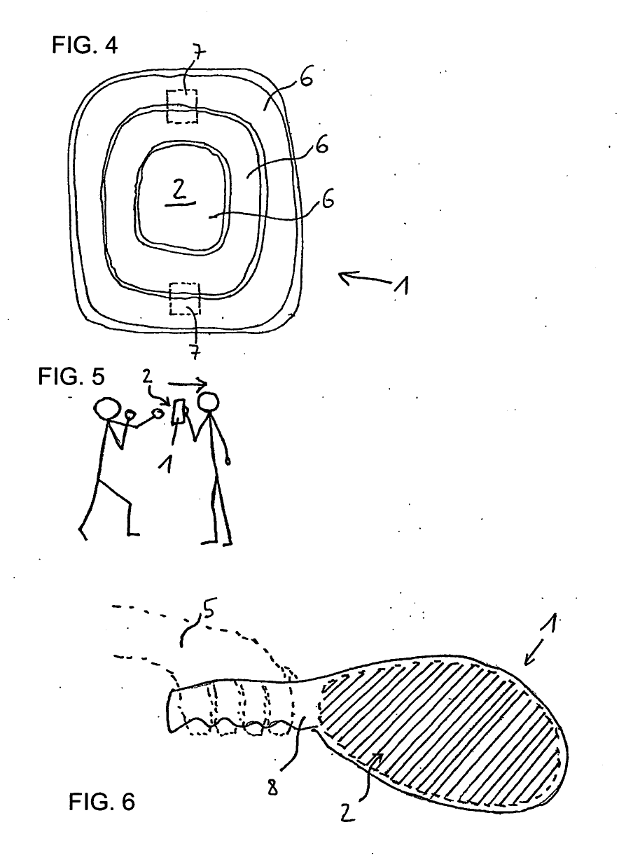

FIG. 4 shows the arrangement of the force sensors and the acceleration sensors of the measuring instrument inside the Coaching Mitts.

FIG. 5 shows the application of the measuring instrument in form of a Coaching Mitt.

FIG. 6 shows a measuring instrument according to the invention in form of a Hand Mitt.

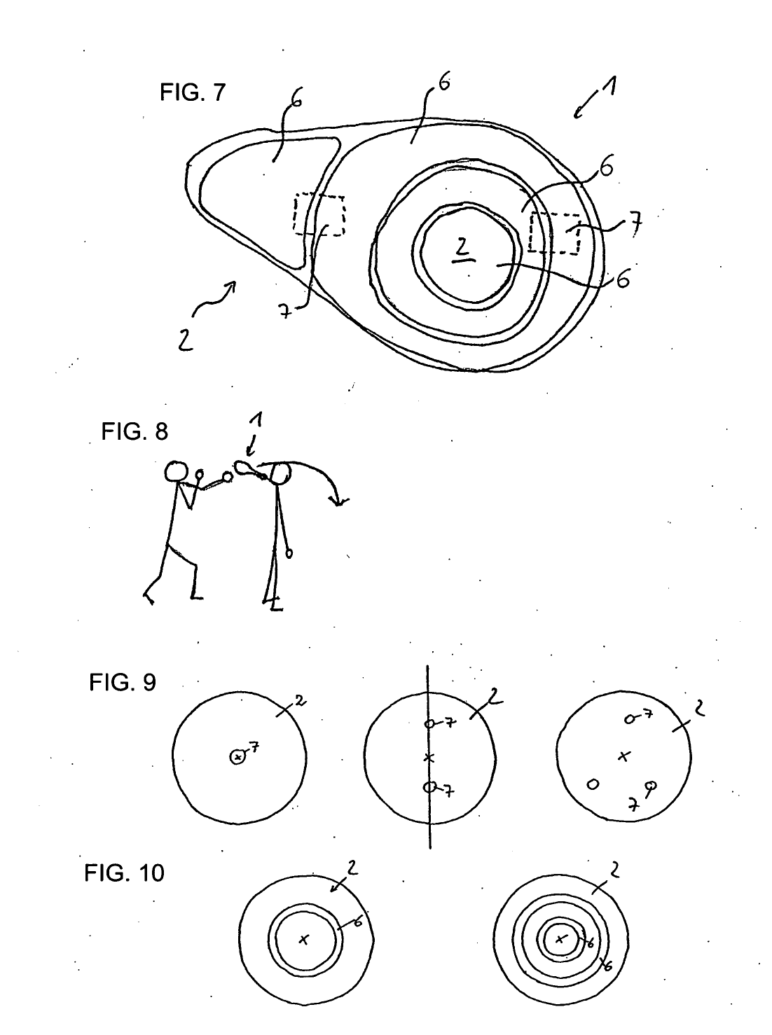

FIG. 7 shows the force sensors and the acceleration sensors of the Hand Mitt in accordance with FIG. 6.

FIG. 8 shows the application of the Hand Mitt.

FIG. 9 shows arrangement possibilities for acceleration sensors.

FIG. 10 shows arrangement possibilities for force sensors.

In the drawings, two different implementation forms of a measuring instrument according to invention 1 are represented. In the FIGS. 1 to 5, a so-called Coaching Mitt is described, in the FIGS. 6 to 8 a so-called Hand Mitt is displayed.

A Coaching Mitt is a training device used in particular for training of martial arts techniques. Such a Coaching Mitt is tightened like a glove and/or fastened to the hand or lower arm 5. In FIG. 1 and FIG. 2, the attachment on a hand 5 is represented. With this implementation form the hand 5 is connected at the palm with the Coaching Mitt 1 by a fixation 3 at the lower arm and a fixation 4. On the side of the measuring instrument and/or the Coaching Mitt 1 opposite to the hand 5, a target surface 2 is designed, which takes up the expected punch or kick and/or on which the punch or kicks has an effect.

In FIG. 5 the application of the Coaching Mitt 1 is shown. The right person in FIG. 5 holds the Coaching Mitt 1 in the hand 5 with the target surface 2 turned to a second person, which is the training person. This person hits the target surface 2. Thus, the impact vector goes through the part of the body holding, i.e. e.g. through the hand 5 of the right person. Such a Coaching Mitt 1 is used above all when it is necessary to be able to oppose more resistance to the blows.

If an impact meets the target surface 2, the Coaching Mitt 1 is pressed to the right in an circle-arc-shaped course from its starting position into a final position. As axis of rotation and/or turning center works thereby, as in FIG. 5 represented, the elbow of the right person. By this movement of the Coaching Mitt 1, a movement plane is defined. This movement plane runs through the center of the target surface 2 in the starting position, through the center of the target surface 2 in the final position as well as through the turning center and/or the elbow. In FIG. 5, the movement plane is aligned vertically to the ground.

FIG. 3 shows the Coaching Mitt 1 from the front, whereby the front is protected by a dirt- and humidity-rejecting cover. In FIG. 4, the Coaching Mitt with removed cover is shown, whereby the arrangement of the sensors 6, 7 of the measuring instrument 1 is recognizable. Three force sensors 6 are intended, implemented as capacitive, inductive, piezo- or FSR force sensors in this example. The three force sensors 6 are arranged circular around the center of the target surface 2 and cover almost the entire target surface 2.

In addition, two acceleration sensors 7, located on the target surface 2, are, on a vertical, in particular perpendicular, line in the prospective movement plane of the Coaching Mitt 1 caused by the impact with regard to the axis of rotation and/or the turning center, i.e. in this case the elbow, are arranged. The two acceleration sensors 7 lie both in the same distance and diametrically to the center of the target surface 2.

In FIGS. 6 to 8, a further implementation form of a measuring instrument 1 is represented, which is out-arranged in form of a Hand Mitt. Such a Hand Mitt 1 is, as shown in FIG. 8, held by a training partner like a racquet. In FIG. 8, the left person, which is the training person, hits the target surface 2 of the Hand Mitt 1. In contrary to the Coaching Mitt 1, the impact vector does not go through the part of the body holding, i.e. the hand 5, but only through the target surface 2. Such a Hand Mitt 1 is above all used, if a goal with less resistance is to be needed, to achieve larger accelerations and/or velocities.

If an impact hits the target surface 2, the Hand Mitt 1 is brought, like the Coaching Mitt 1, in a circle-arc-shaped course from its starting position to the right into a final position in accordance with FIG. 5. However, not the elbow works thereby as axis of rotation and/or turning center, but rather the shoulder joint of the right person. By this movement of the Hand Mitt 1, a movement plane is defined. This movement plane runs through the center of the target surface 2 in the starting position of the Hand Mitt 1, through the center of the target surface 2 in the final position as well as through the turning center and/or the shoulder joint. In FIG. 5, the movement plane is aligned diagonally and/or almost horizontal to the ground.

In FIG. 6, the fundamental structure of such a Hand Mitt 1 is represented, whereby a handle 8 is intended, to which the target surface 2 connects. The target surface 2 of this in FIG. 6 represented implementation form is not circular or oval out-arranged, but has a rather oblong basic form. At differently arranged Hand Mitts 1 the target surface 2 can also be out-arranged in a circle or oval shape.

In FIG. 7, the target surface 2 of FIG. 6 is displayed in detailed view. The target surface 2 is divided into two ranges: in a right subrange, which essentially exhibits circle or an oval surface area, and a left essentially triangular subrange near the hand grip 8.

In the right subrange, three force sensors 6 are arranged, similar to the implementation form in accordance with FIGS. 1 to 5 as concentric rings around a center of the right subrange of the target surface 2. Also in this implementation form, the force sensors 6 are designed flatly.

A further force sensor 6 is arranged in the left subrange of the target surface 2 and represents an essentially triangular surface area.

In addition, two acceleration sensors 7, located on the target surface 2, are arranged in a straight line, in particular in an extension of the handle 8, in the movement plane presumably caused by the impact with regard to the axis of rotation and/or the turning center. The two movement sensors 7 can be arranged in same distance and/or diametrically to the center of the right part of the target surface 2. Further arrangement possibilities for the force sensors 6 and the acceleration sensors 7 are displayed in FIGS. 9 and 10.

As force sensors 6, capacitive receivers can be used, with which forces affecting them cause a change in distance of a plate capacitor and thus a change in the capacity and impedance, Moreover, there is conceivable the usage of inductive receivers, which work according to the moving coil principle or Hall sensors. Furthermore, also so-called FSR (Force Sensing Resistance and/or Force Sensitive Resistor) sensors are possible, with which the resistance value changes by the application of force, and/or foils, whereas voltages are generated proportionally to the mechanical influence by the piezoelectric effect.

As acceleration sensors, advantageously MEMS (Micro Electro Mechanical System) sensors are used. These are characterised by a far measuring range, good linearity as well as its small and durable design.

With the measuring instrument according to invention 1 two parameters, i.e. on the one hand the concrete force values and on the other hand the concrete acceleration values, are determined directly. Thus the system becomes more meaningfully, because, besides, from only one parameter at mobile applications, the further interesting values can not derived. Also the measuring instrument 1 thereby becomes mass-independent and is suitable for the use as handheld equipment, which for is favourable for training devices. The force values and the acceleration values are accordingly registered on a value basis and the concrete values flow into the evaluation and the calculation of the characteristics for the qualitative evaluation of the impact, like e.g. the power, etc. Thus, with the measuring instrument according to invention 1 it is not only determined whether a certain threshold and/or a certain limit value is crossed, for example whether the impact exceeds a certain minimum strength and only then is at all seized.

From the determined values force and acceleration, a plurality of further parameters are determined through well-known physical connections, which supply a statement about the quality of the hit. Beside the primary, actually already important parameters force and acceleration, know so speed, way, momentum, transferred energy, power can be computed:
Velocity v(t)=a(t)*dt (including determination of the maximum speed)
Covered distance of the target s(t)=∫v(t)*dt=∫∫a(t) dt²
Momentum p(t)=∫F(t)*dt
Transferred energy W(t)=F(t)*s(t)=F*a*t²=F(t)*∫∫a(t) dt²
Power P(t)=W(t)/t=F*a*t=F(t)*a(t)*dt

Furthermore, time conditions can be determined, for example the relationship between contact- and die time. In addition also the affected mass dm(t)=dF(t)/da(t), depending upon the resistance of the training partner, can be computed.

In addition, all parameters are given in their time course, not only for example as scalar maximum value. So from the morphologic course of the curve and/or the profile, important information about the performance of the implemented impact can be determined.

Additionally, it is possible to judge aim- and hit accuracy by the use of several sensors distributed over the entire Target surface. For this, different algorithms, e.g. triangulation, can be used. In the case of appropriate resolution, i.e. number of force sensor areas, also the pressure as force per surface of the area can be determined. With the realization of the measuring instrument 1 as a Hand Mitt, two acceleration sensors 7 in the equipment can be installed, in order to determine also rotation speeds and turning radii.

The measuring instrument 1 possesses advantageously an integrated display, on which the results can be displayed. Besides, the connection through a data interface (e.g. over cables, radio, NFC, optical or other methods) to a data processing equipment (for example PC, PDA, mobile telephone etc.) is possible, to indicate results and store them in a data base, for example to support assessment of physical performance. In addition, also whole training programs and set points can be integrated.

The power supply is made preferably by means of integrated accumulators, which can be recharged, either conventionally or by admission of kinetic energy.

The conversion for other kinds of sport is just as possible with an appropriate adaptation. In principle, each sport equipment, which is actively or passively involved in impact processes, can be equipped with the system, for example all kinds of sport, with which a played object is hit by a racquet or a part of the body, like e.g. Football, Volleyball, tennis, table tennis, baseball, Hockey, ice hockey, gulf, Cricket, Polo etc., whereby the measuring instrument 1 and/or the sensors 6.7 in the racquet and/or Part of the body (clothing, e.g. shoe, glove) accommodated and/or are fastened to the racquet/part of the body.

The measuring instrument is also applicable for the diagnostics of the release behavior for kinds of sports, in which an object is thrown or pushed, for example for ball pushing, javelin, discus etc.

In principle two cases are to be distinguished: in the first case an active part (part of the body, racquet, object) hits a target with measurement unit (e.g. fist on Mitt, ball on glove, racquet on ball). In this case the collection takes place in the target, which is naturally not rigidly embodied. In the second case a moved, active part, equipped with the measuring instrument (part of the body/article of clothing, racquet) hits a target (ball, object, etc.).

In both cases, the capture of the parameters is generally only allowed by the invention-appropriate measuring arrangement, because in all cases, movable/moved objects are to be looked which are partially connected with a body part and lead, in particular through this coupling, to dynamically variable parameters, which are not detectable by present methods.

1. Impact pad, in particular for a coaching mitt or hand mitt, the surface or impact surface of which is designed as a target surface (2), the impact pad comprising a measuring device for detecting and evaluating an impact, punch or impulse impinging upon the target surface (2), characterized in that
at least one force sensor is provided for detecting on a value basis the force acting upon the target surface as a result thereof;
at least one acceleration sensor (7) is provided for detecting on a value basis the acceleration acting upon the target surface as a result thereof;
the force sensor (6) and the acceleration sensor (7) are actively connected with the target surface (2) and are arranged either on or behind the target surface; and
the force sensor (6) and the acceleration sensor (7) are connected to an evaluation unit (9) for processing the detected force- and acceleration values, in which unit the characteristic variables for qualitative evaluation of the punch are computed from the concrete, value-based detected force- and acceleration values.

2. Impact pad according to claim 1, characterized in that the target surface (2) is essentially circular or oval.

3. Impact pad according to claim 1, characterized in that the force sensors (6) are designed as capacitive, inductive or FSR (Force Sensing Resistor) sensors.

4. Impact pad according to one of claims 1 to 3, characterized in that the force sensors (6) are designed as laminar force sensors (6) and cover in particular at least a majority to the complete of the target surface (2).

5. Impact pad according to one of claims 1 to 4, characterized in that the acceleration sensors (7) are designed as MEMS (Micro Electro Mechanical system) sensors.

6. Impact pad according to one of claims 1 to 5, characterized in that only one acceleration sensor is intended (7), which is arranged in and/or near the center of the target surface (2) and/or central behind the target surface (2) in the hit direction.

7. Impact pad according to one of claims 1 to 6, characterized in that two acceleration sensors (7) are intended, which are arranged on a line that is defined in the movement direction of the measuring instrument (1) and/or the target surface (2) defined movement plane, which is defined by the center of the target surface (2) in the starting position, by the center of the target surface (2) in the final position and the turning center, around which the measuring instrument (1) is moved in the use, in particular an elbow or similar, is preferably equidistant, and/or diametrically to the center of the target surface (2), in particular in an extension of a handle (8).

8. Impact pad according to one of claims 1 to 6, characterized in that at least three acceleration sensors (7) on the target surface (2) are intended, which span a plane, that lies in normal direction to the impact vector, and are arranged in that plane, in particular linearly independently, mainly equidistant to the centre of the target surface (7), mainly at regular intervals to each other.

9. Impact pad according to one of claims 1 to 8, characterized in that only one force sensor (6) is intended, that is implemented as laminar, in particular capacitive, force sensor (6) which covers the target surface (2) preferably as completely as possible.

10. Impact pad according to claim 9, characterized in that the force sensor (6) is arranged circularly around the center of the, in particular approximately circular or oval, target surface (2).

11. Impact pad according to one of claims 1 to 8, characterized in that at least two circular force sensors (6) are intended, which are arranged concentrically around the center of the, in particular approximately circular or oval, target surface (2).

12. Impact pad according to claim 10 or 11, characterized in that the circular force sensors (6) have a ring width of at least 10 millimetres.

13. Impact pad according to one of claims 1 to 12, characterized in that the target surface (2) has a shape deviating from the circle or the oval form, whereby a circular or oval first section and a second section covering the remaining target surface (2) is implemented, whereby in each section at least one force sensor (6) is intended, whereby the force sensor (6) in the first section is arranged preferably in accordance with characteristics of claims X-Y.

14. Impact pad according to one of claims 1 to 13, characterized in that at least three punctual, in particular FSR, force sensors (6) are intended, in a common plane aligned normally on the blow direction, in particular linear independently, equidistantly to the center of the target surface (2), and/or arranged by same distances to one another.

15. Impact pad according to one of claims 1 to 14, characterized in that with the evaluation unit (9), at least the velocity, the way, the momentum, the transferred energy, the power and further characteristics for the qualitative evaluation of the impact and/or blow is calculable.
